(19) United States
(12) Patent Application Publication
(10) Pub. No.: US 2009/0009137 A1
(43) Pub. Date: Jan. 8, 2009

(54) Apparatus and method to integrate the power management IC with the system IC

(76) Inventor: Jun Zhang, Richardson, TX (US)

Correspondence Address: Jun Zhang, 4416 Greenfield Dr, Richardson, TX, 75082, US

(21) Appl. No.: 11/773,515

(22) Filed: Jul. 5, 2007

(51) Int. Cl. H02J 7/00; G05F 1/10

(52) U.S. Cl. 320/137; 323/283

(57) ABSTRACT

Apparatus and method to integrate a digital pulse width modulation controller, a digital battery charger controller, and other power management functions in a digital system integrated circuit to increase the design flexibility, manufacture simplicity, improve efficiency, and reduce the complexity and cost of the system design is disclosed. The digital controller and power management circuit can be designed and stored in program code to be implemented when the system is designed. The power management devices and the system can share resources including ADCs, memory, computing function and communication function.

### BACKGROUND OF INVENTION

1. Technical Field

The present invention is related in general to power management, particularly to digital power supply control that provides electrical power to an electronic system such as computing, communication, and the like.

2. Background Information

Semiconductor integrated circuits (ICs) have gained great popularity in modern electronic system. The semiconductor integrated circuit such as central process unit (CPU), digital signal processor (DSP), and field programmable gate array (FPGA) etc. are powered by direct current (DC) power sources. The modern DC power source is usually provided by switching mode power supply or battery. The DC power supply could be a module or a set of discrete components on a system board. The heart of these components is a pulse width modulation (PWM) controller that regulates the power supply output. The PWM controller is a stand along integrated circuit chip. Most of PWM controllers will require a compensation network to stabilize the power supply output. Some system will require battery to back up for temporary power outage or to provide the power for a period of time for the portable devices. Sophisticated battery management ICs including battery charger controllers, battery monitoring ICs are needed for the battery powered system. This invention is to integrate PWM controllers, compensation network and/or battery management ICs into a system IC chip to improve the flexibility, simplicity, efficiency and cost effectiveness of the total system.

### BRIEF SUMMARY OF THE INVENTION

A PWM controller for switching mode power supply is usually a stand along IC. A traditional PWM controller is made of analog circuit. It is usually fixed in power supply topology and operation. The characteristic of the chip is very manufacture process depended. Since the system IC is very different from one to another, it is impractical to integrate in an analog PWM controller to a system IC.

A digital PWM controller for switching mode power supply has gained great popularity in recent years. The digital PWM controller is largely independent of the manufacture process. It can be manufactured with the same process that used to manufacture the system IC. This made it attractive to integrate the digital PWM controller inside the system IC. The digital PWM controller can be design in hardware description language such as VHDL or Verilog. This made it easy to implement the digital PWM controller design inside the system IC at time when the system IC is designed.

The digital PWM controller and the compensation circuit for the power supply can be designed and verified for different topology and operation separately. The design will be stored in digital format to be implemented in the system IC for different system application.

The flexibility and reusability of the design is greatly increased because that the PWM controller and the compensation network design is stored in digital format. Since the PWM controller is inside of system IC, it is easier for the PWM controller to change operational mode of a power supply to increase efficiency and system performance with information of system operation. The system cost will be reduced by eliminate the need for a separated power supply controller.

Digital battery management IC such as battery charger controller is very similar with the PWM controller. Digital battery management IC can be integrated in a system IC in a same way to achieve same benefits.

### BRIEF DESCRIPTION OF THE DRAWING

FIG. 1 depicts a block diagram of a typical prior art system board with system ICs and a set of power management components that functions as a power supply.

FIG. 2 depicts one embodiment of the present invention, a PWM controller, a compensation network, a protection circuit and a system or a part of system integrated in one IC chip.

FIG. 3 depicts a typical system board block diagram with one embodiment of the present invention in which a PWM controller, a compensation network, a protection circuit and a system or a part of system are integrated in one IC chip.

FIG. 4 depicts one embodiment of the present invention, a PWM controller, a compensation network, a protection circuit, an analog to digital converter and a system or a part of the system are integrated in one IC chip.

FIG. 5 depicts one embodiment of the present invention, a PWM controller, a compensation network, a protection circuit, an analog to digital converter, a voltage reference, a startup linear regulator, drivers, semiconductor switches and a system or a part of the system are integrated in one IC chip.

FIG. 6 depicts a typical application of one embodiment of the present invention that a system IC is powered by a buck converter where a PWM controller, a compensation network, a protection circuit, an analog to digital converter, a voltage reference, a startup linear regulator, drivers, semiconductor switches and a system or a part of the system are integrated in one IC chip.

### DETAILED DESCRIPTION OF THE INVENTION

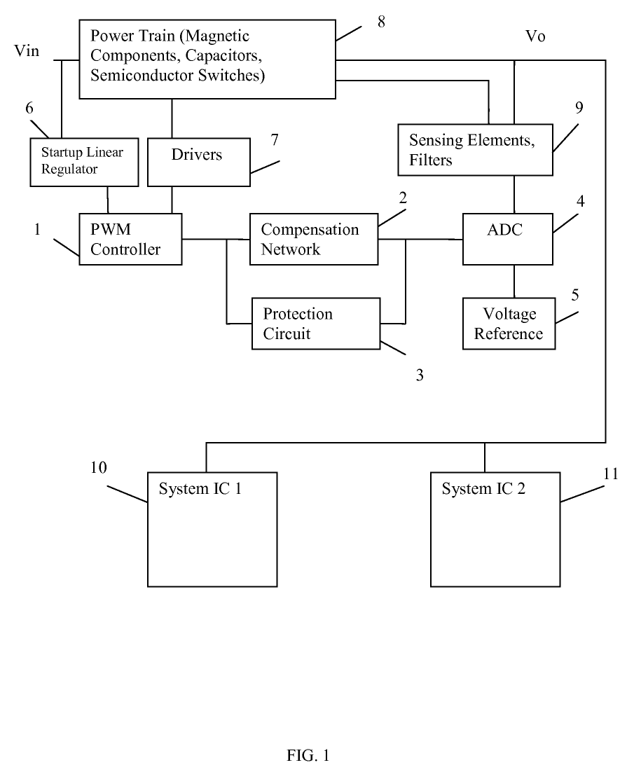

An electronic system, such as computer, network equipment, cell phone, etc. consists of one or more print circuit board (PCB) assembly. A typical prior art PCB assembly consists of one or more system IC (10) and (11) in FIG. 1, and power supplies and or sets of power management components that provide power supply functions. The system IC contains a system or a part of a system that performs the main functions of the designed system board such as computing, communication, control, data processing etc. As shown in FIG. 1, a set of power management component that provides the digital power supply function comprises of a digital PWM controller (1), a compensation network (2), a protection circuit (3), an analog to digital converter (ADC) (4), a voltage reference (5), a startup linear regulator (6), drivers (7), a power train (8), and sensing elements and filters (9). The power train is the main part of a power supply circuit that processes the power. It comprises magnetic components, capacitors, and semiconductor switches. The magnetic components, capacitors, and semiconductor switches are couple from one to another in ways that well defined by power supply topologies. The sensing elements are coupled to the power train to sense characteristics of it. The characteristic information is coupled to ADCs through proper filtering. The ADC converts the analog signals to digital signals with a voltage reference. The digital signals from the ADC are coupled to a compensation network and a protection circuit for processing. The processed signals from the compensation network and the protection circuit are coupled to the PWM controller. The compensation network processes the feedback signal of a power train for the PWM controller to keep the power train stable. The protection circuit protects the power train from being damaged by over current, over voltage, over temperature etc. The protection circuit compares the power train signal from ADCs to a set of value and instructs the PWM controller to shutdown the power train when risks occur. The PWM controller is coupled to the divers which drive the semiconductor switches of the power train. With one end the startup linear regulator coupled to input, the other end couples to the PWM controller and other circuit that need power for initial startup. Once the power train started, the linear regulator can be turn off. All the operation power can be provided by the power train. The output of the power supply Vout is coupled to the power input of system ICs to provide the electrical power for the system operation. Only one power supply output is shown in FIG. 1, but there can be multi outputs for multi system ICs that operate at different voltage.

In theorem, all the semiconductor parts and controlling functions can be integrated together in one system IC. However the different integration level will have different advantage for different application in practice.

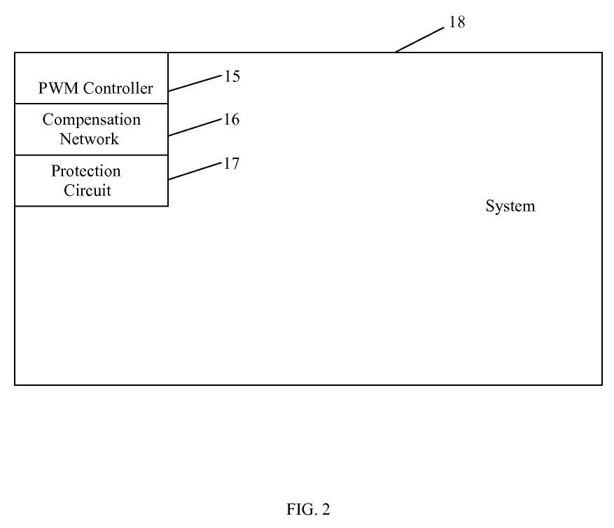

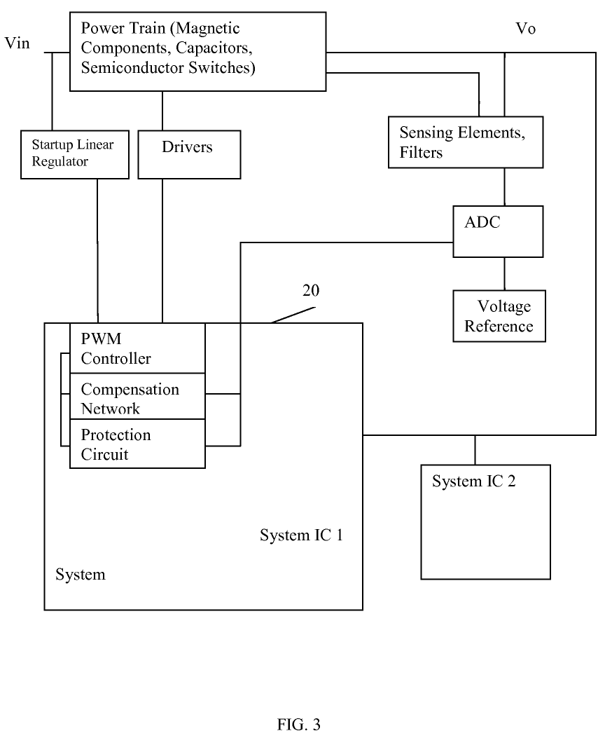

For maximum flexibility and minimum impact on the design and manufacture of system IC, according to one embodiment of the invention as shown in FIG. 2, a PWM controller (15), a compensation network (16), a protection circuitry (17) are integrated with one of the system IC (18). With this embodiment of the present invention, the prior art PCB assembly block diagram as shown in FIG. 1 is simplified to the block diagram shown in FIG. 3 where one system IC (20) includes a system or a part of system, a PWM controller, a compensation network, and a protection circuit. The design methodology and manufacture of the digital PWM controller, the digital compensation network and the protection circuitry are same with a typical digital integrated circuit. The digital PWM controller, the digital compensation network and the protection circuitry can be designed and tested separately. The design will be stored in form of program code in hardware description language or other software language. In one embodiment of the present invention, the digital PWM controller is re-configurable by changing the program code. When the system is being designed, the soft PWM controller, the soft compensation network and the soft protection circuitry will be selected and implemented. In one embodiment of the present invention, the system selects the digital PWM controller by loading the program code. The soft PWM controller, the soft compensation network and the soft protection circuitry can be customized to optimize the system performance.

In one embodiment of the present invention, the communication between a PWM controller and a system is established by an internal data bus that connecting them. The system power requirement information can be accessed by the PWM controller. The PWM controller will decide which power supply configuration and operation mode is best at the particular situation base on the system operation information. If the system is going to lower power consumption mode, the PWM controller can turn off parts of power train and/or reduce the switching frequency to improve the efficiency. The system can control the system operation mode base on the power supply condition. The system can delay some high power consumption operation to prepare the power train if the power supply is at low power operation mode to avoid fault situation.

In one embodiment of the present invention, an integrated digital PWM controller and a system can share the same resources such as ADC, communication function, computing function, memory, display interface etc. Some of the function such as ADC is not used at all time by the system or the PWM controller. This makes it possible that they can be share through multiplexing. The resource including computing, communication, logic operation, and memory that assigned to the system is usually many times more than the PWM controller. In one embodiment of the present invention, the resources of the system can be used to diagnostic, optimization and report the power supply design before it is finalized. Using a buck converter with synchronous rectifiers as an example, the delay between the two switches is very important for power efficiency. The controller will try a few different options, and then uses the resource of system do the calculation and comparison. The controller will use the best delay time after this optimization. The resource will be released back to the system when the diagnostic and optimization is finished. In one embodiment of the present invention, the calibration is done with the resource of system in a way same as optimization.

A battery charger is similar to a PWM controller in many ways. The function of the battery management IC includes the controlling of a battery charger, battery monitoring, identification and reporting. Digital battery management ICs can be integrated in a system IC in a same way as a digital PWM controller.

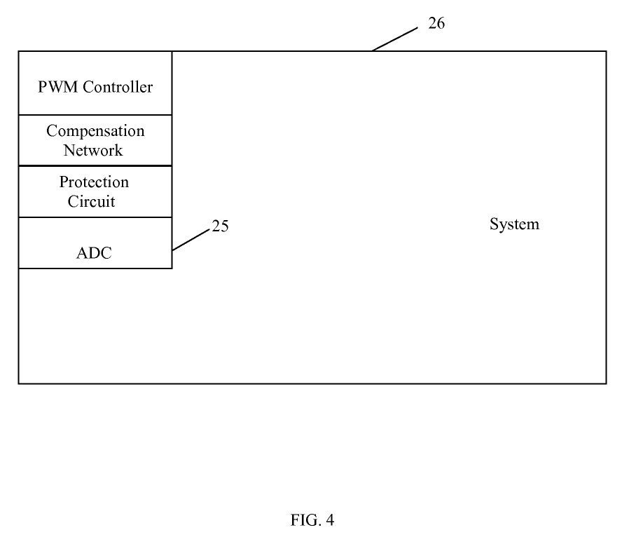

In one embodiment of the present invention, an ADC (25) is also integrated in a system IC (26) as shown in FIG. 4. The ADC can be shared with the system through multiplexing. The number of pin will be reduced as well.

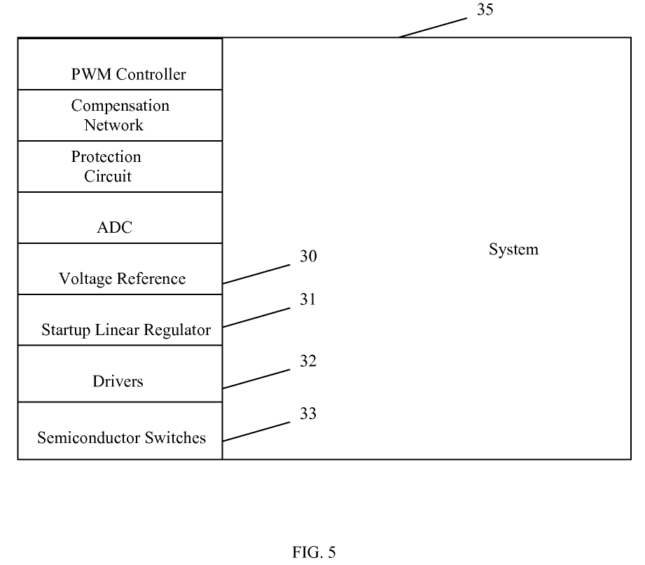

In one embodiment of the present invention, a voltage reference (30) is also integrated in a system IC (35) as shown in FIG. 5. The voltage reference is couple to the ADC and the system. In one embodiment of the invention, the voltage reference is calibrated during manufacture test. The calibration data is store in the system memory. This will reduce precision requirement during manufacture and dependence on the environment.

In one embodiment of the present invention, a startup linear regulator (31) is also integrated in the system IC (35) as shown in FIG. 5 to reduce the part count. The startup linear regulator is coupled the PWM controller and other part of circuit to provide initial power for power supply and system startup. The linear regulator can be turned off by a switch when the switching power supply is operating to improve the efficiency and reduce the component size of the linear regulator.

In one embodiment of the present invention, drivers (32) for semiconductor switches are integrated in the system IC (35) as shown in FIG. 5. The drivers which are coupled to the PWM controller are relatively small compare to the power switch and are compatible with some system IC in term of manufacture process. This is highest integration level without the power switches which are much large in term of silicon area.

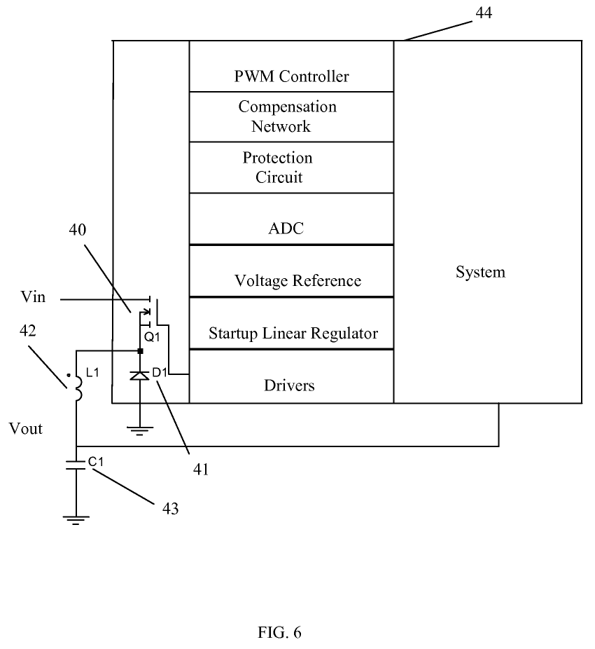

To achieve the total integration, semiconductor switches (33) are integrated in the system IC (35) as shown in FIG. 5. The semiconductor switches are coupled to the drivers. All semiconductor devices are in one IC chip. This significantly simplifies the design and manufacture of the electronics equipments and devices and is particularly useful for small system. FIG. 6 depicts a typical application where the semiconductor switches (34) in FIG. 5 are replaced by MOSFET Q1 (40) and diode D1 (41). The system IC (44) in FIG. 6 is powered a buck converter. Only inductor L1 (42) and capacitor C1 (43) in FIG. 6 are the discrete components. The output of the buck converter is connected to the system power input. More system ICs can be powered by paralleling. The complexity of the system design and system part count is significantly reduced with this embodiment of the present invention.

What is claimed is:

1. A semiconductor digital integrated circuit comprising a digital PWM controller; a digital power supply compensation network; a digital power supply protection circuitry; a system or a part of system that perform functions including computing, communication, control, and data processing. The digital power supply compensation network and the digital power supply protection circuit are coupled to the digital PWM controller. The digital PWM controller can be coupled to the system or the part of the system.

2. The semiconductor digital integrated circuit in claim 1 further comprising analog to digital converters (ADCs). The ADCs are coupled to the power supply compensation network, the power supply protection circuit and/or the system.

3. The semiconductor digital integrated circuit in claim 1 further comprising a voltage reference. The voltage reference is coupled to the ADCs. The voltage reference is calibrated with resources of the system including ADC, memory, registers, computing function, logic operation, and communication function.

4. The semiconductor digital integrated circuit in claim 1 further comprising a startup linear regulator. The startup linear regulator is coupled to the digital PWM controller and other circuit including drivers, voltage reference, and ADC that needs the power during power supply startup.

5. The semiconductor digital integrated circuit in claim 1 further comprising drivers. The drivers are coupled to the digital PWM controller to boast the output power and/or voltage to drive semiconductor switches.

6. The semiconductor digital integrated circuit in claim 1 further comprising semiconductor switches. The semiconductor switches are coupled to the drivers to process the power that needed for the system

7. The semiconductor digital integrated circuit in claim 1 wherein the digital PWM controller is re-configurable by changing a program code.

8. The semiconductor digital integrated circuit in claim 1 wherein the system selects and loads a PWM controller program code as needed.

9. The semiconductor digital integrated circuit in claim 1 further comprising a data bus connecting the digital PWM controller and the system. The data bus is used to communicate information that including power supply configuration, switching frequency, power supple input voltage, output current, system operation mode between the PWM controller and the system. The PWM controller is re-configured to change the power train and operation mode base on the information of the system. The system controls the system operation mode base on the information of the PWM controller to avoid fault situation.

10. The semiconductor digital integrated circuit in claim 1 wherein the system and the PWM controller share resources including ADC, voltage reference, memory, registers, computing function, logic operation, and communication function.

11. The semiconductor digital integrated circuit in claim 1 wherein the PWM controller performs the diagnostic, optimization and reporting of the power train with resources of the system including ADC, voltage reference, memory, registers, computing function, logic operation, and communication function.

12. The semiconductor digital integrated circuit in claim 1 wherein the PWM controller, the compensation network, and the protection circuit are calibrated with resources of the system including ADC, voltage reference, memory, registers, computing function, logic operation, and communication function.

13. A semiconductor digital integrated circuit comprising a digital battery charger controller; a digital battery charger compensation network; a digital battery charger protection circuitry; and a system or a part of system that perform functions including computing, communication, control, and data processing. The digital battery charger compensation network, the digital battery charger protection circuit are coupled to the digital battery charger controller. The digital battery charger controller can be coupled to the system.

14. The semiconductor digital integrated circuit in claim 13 further comprising digital battery management functions including battery monitoring, battery identification, battery life reporting. The digital battery management functions and the system can share resources including ADC, voltage reference, memory, registers, computing function, logic operation, and communication function. The digital battery management functions can be calibrated by the resource of system including ADC, voltage reference, memory, registers, computing function, logic operation, and communication function.

15. The semiconductor digital integrated circuit in claim 13 further comprising analog to digital converters (ADCs). The ADCs are coupled to the battery charger compensation network and the battery charger protection circuit and/or the system.

16. The semiconductor digital integrated circuit in claim 13 further comprising a voltage reference. The voltage reference is coupled to the ADCs. The voltage reference is calibrated with resources of the system including ADC, memory, registers, computing function, logic operation, and communication function.

17. The semiconductor digital integrated circuit in claim 13 further comprising a startup linear regulator. The startup linear regulator is coupled to the battery charger controller and other circuit including drivers, voltage reference, and ADC that needs the power during power supply startup.

18. The semiconductor digital integrated circuit in claim 13 further comprising drivers. The drivers are coupled to the PWM controller to boast the output power and/or voltage to drive semiconductor switches.

19. The semiconductor digital integrated circuit in claim 13 further comprising semiconductor switches. The semiconductor switches are coupled to the drivers to process the power to charge the battery.

20. The semiconductor digital integrated circuit in claim 13 wherein the system and the digital battery charger controller share resources including ADC, voltage reference, memory, registers, computing function, logic operation, and communication function.

21. The semiconductor digital integrated circuit in claim 13 wherein the battery charger controller, the compensation network, and the protection circuit are calibrated with resources of the system including ADC, voltage reference, memory, registers, computing function, logic operation, and communication function.
